(19) United States
(12) Patent Application Publication
(10) Pub. No.: US 2009/0272223 A1
(43) Pub. Date: Nov. 5, 2009

(54) Cam Device Incorporated with a Hinge

(76) Inventor: Chao-Chi Lin, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/113,995

(22) Filed: May 2, 2008

(51) Int. Cl. F16H 53/00

(52) U.S. Cl. 74/567

(57) ABSTRACT

A cam device has an improved stableness in operability including a first member and a second member incorporated with each other. The first member has an engaging surface defining engaging portions moveable relative to engaging portions on an engaging surface of the second member. Each engaging portion has a top edge having two ends, a first slope extending from one end of the top edge, and a second slope extending from the other end of the top edge. Each first slope has one other first slope circumferentially spaced at an angle of 180° and each second slope has one other second slope circumferentially spaced at an angle of 180°. Additionally, each engaging portion has a central angle measured from a point within the cam device and an imaginary line dividing the central angle in half adapted to cooperate with another line to form an angle of 180°

### BACKGROUND OF THE INVENTION

1. Field of the Invention

The present invention relates to a cam device, in particular to a cam device that is incorporated with a hinge and such a cam device has an improved stableness in operability.

2. Description of the Related Art

Referring to China Patent No. 200620137499.1, a cam device includes a first member having protrusions that are formed of points abutting against a second member and that are moveably relative to the second member. While it is advantageous that the first and second members have relative small engagement areas for noise reduction during operation, these engagements however suffer rocking motions between relative movement of the first and second members rendered by any elastic behavior of resilient elements incorporated with the cam device. Additionally, the cam device has not yet provided the most effortless way for starting relative movement of the first and the second members.

Referring to China Patent No. 200620115146.1, a cam device that is more durable for use is disclosed. However, the cam device still suffers the abovementioned problems.

The present invention is, therefore, intended to obviate or at least alleviate the problems encountered in the prior art.

### SUMMARY OF THE INVENTION

In one aspect of the present invention, a cam device includes a first member and a second member incorporated with each other. The first member has an engaging surface defining engaging portions moveable relative to engaging portions on an engaging surface of the second member. Each engaging portion has a top edge having two ends, a first slope extending from one end of the top edge, and a second slope extending from the other end of the top edge. Each first slope has one other first slope circumferentially spaced at an angle of 180° and each second slope has one other second slope circumferentially spaced at an angle of 180°. Additionally, each engaging portion has a central angle measured from a point within the cam device and an imaginary line dividing the central angle in half adapted to cooperate with the other similar line of the other engaging portion to form an angle of 180°

In another embodiment of the present invention, each engaging portion has an imaginary line dividing the central angle in half and adapted to cooperate with the other similar line of the other engaging portion to form an angle of 90°.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

For the present disclosure to be easily understood and readily practiced, the present disclosure will now be described in conjunction with the following figures, wherein;

FIG. 1 is an exploded perspective view of a cam device in accordance with a first embodiment of the present invention.

FIG. 2 is a side view of the cam device of the present invention.

FIG. 3 is a cross-sectional view taken along line 3-3 of FIG. 2.

FIG. 4 is an operational position of the cam device of FIG. 1.

FIG. 5 is a cross-sectional view taken along line 5-5 of FIG. 4.

FIG. 6 is an exploded perspective view of a cam device in accordance with a second embodiment of the present invention.

FIG. 7 is a sectional view showing an operational position of the cam device of FIG. 6.

### DETAILED DESCRIPTION OF THE PREFERRED EMBODIMENT

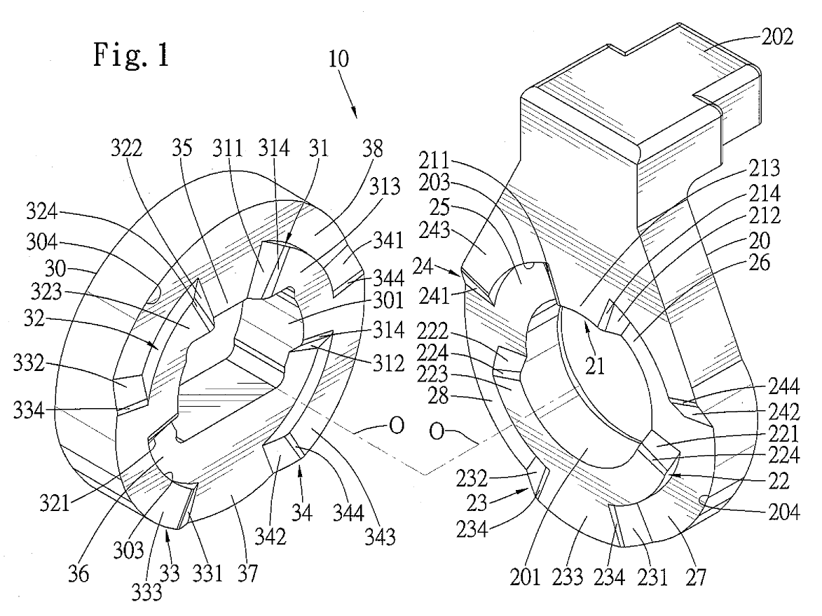

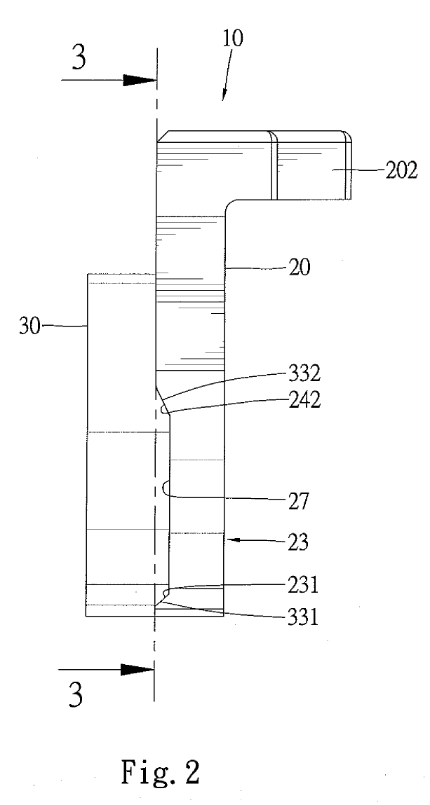

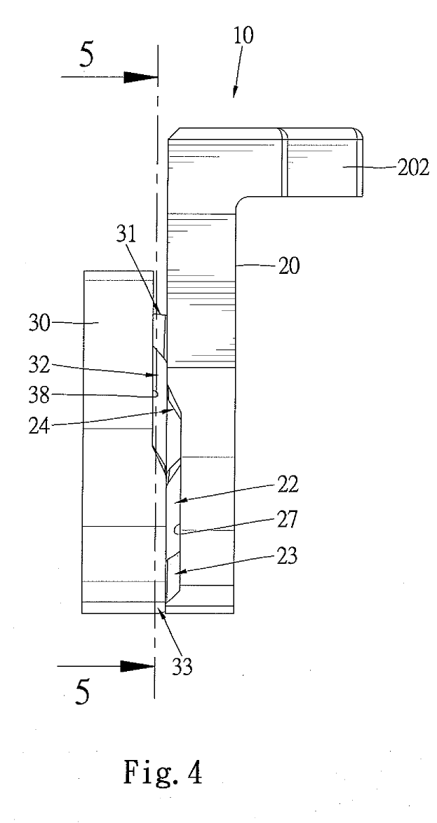

Referring to FIGS. 1 through 5, a cam device 10 in accordance with a first embodiment of the present invention comprises a first member 20 and a second member 30 incorporated with each other. The first and the second members 20 and 30 are coaxially positionable on a pivoting element, preferably a pin-like structure. The pin is inserted though a hole 201 defined in the first member 20 and a hole 301 defined in the second member 30. Additionally, the first member 20 may have a hooking portion 202 adapted to incorporate with a supporting bracket (not shown) of a hinge assembly.

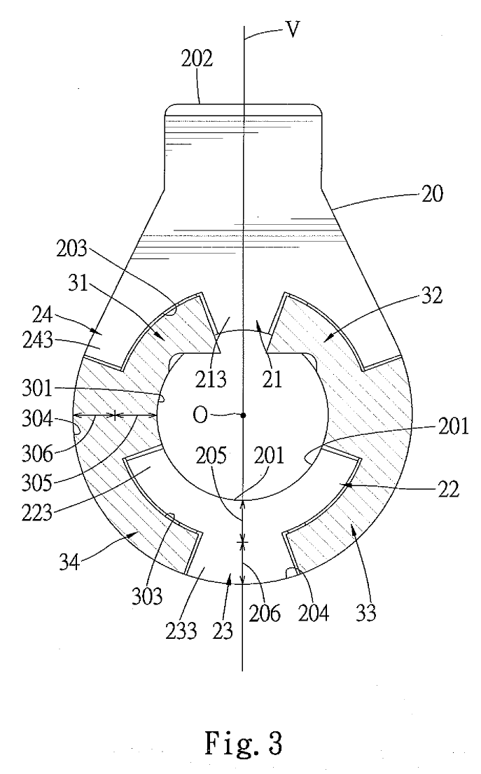

The first member 20 has an engaging surface and the second member 30 has an engaging surface positioned against the engaging surface of the first member 20 and moveable relative to the engaging surface of the first member 20. As best shown in FIG. 3, the engaging surface of the first member 20 defines an inner section 205 and an outer section 206. The inner section 205 has an inner perimeter that coincides with the perimeter of the hole 201 and an outer perimeter 203. The outer section 206 has an inner perimeter that coincides with the outer perimeter 203 of the inner section 205 and an outer perimeter that coincides with a perimeter 204 of the engaging surface of the first member 20.

The inner section 205 has a first and a second engaging portions 21 and 22, preferably a protruded configuration, thereon and spaced by a third and a fourth engaging portions 25 and 26 forming portions of surface defining the inner section 205. The first, second, third and fourth engaging portions 21, 22, 25 and 26 have shapes symmetrical with respect to line V. Additionally, the first and the second engaging portions 21 and 22 have their respective central angles with respect to point O halved by line V and therefore a line dividing the central angle of the first engaging portion 21 in half and a line dividing the central angle of the second engaging portion 22 in half cooperate to form an angle of 180° and these lines coincide with line V. Additionally, the third and fourth engaging portions 25 and 26 are disposed symmetrically with respect to line V and have their respective central angles with respect to point O being equal.

In addition, the first engaging portion 21 defines a top edge 213 which is preferably a planar surface, a slope 211 bridging the third engaging portion 25 and the top edge 213, a slope 212 bridging the fourth engaging portion 26 with the top edge 213, and two chamfered edges 214, with one interconnecting the slope 211 and the top edge 213 and another interconnecting the slope 212 and the top edge 213. The second engaging portion 22 defines a top edge 223 which is preferably a planar surface, a slope 221 bridging the fourth engaging portion 26 and the top edge 223, a slope 222 bridging the third engaging portion 25 with the top edge 223, and two chamfered edges 224, with one interconnecting the slope 221 and the top edge 223 and another interconnecting the slope 222 and the top edge 223.

The outer section 206 has a first and a second engaging portions 23 and 24, preferably a protruded configuration, thereon and spaced by a third and a fourth engaging portions 27 and 28 forming portions of surface defining the outer section 206. The first, second, third and fourth engaging portions 23, 24, 27 and 28 have shapes symmetrical with respect to line V. Additionally, the first and second engaging portions 23 and 24 have their respective central angles with respect to point O halved by line V and therefore a line dividing the central angle of the first engaging portion 23 in half and a line dividing the central angle of the second engaging portion 24 in half cooperate to form an angle of 180° and these lines coincide with line V. Additionally, the third and fourth engaging portions 27 and 28 are disposed symmetrically with respect to line V and have their respective central angles with respect to point O being equal.

In addition, the first engaging portion 23 defines a top edge 233 which is preferably a planar surface, a slope 231 bridging the third engaging portion 27 and the top edge 233, a slope 232 bridging the fourth engaging section 28 and the top edge 233, and two chamfered edges 234, with one interconnecting the slope 231 and the top edge 233 and another interconnecting the second slope 232 and the top edge 233. The second engaging portion 24 defines a top edge 243 which is preferably a planar surface, a slope 241 bridging the fourth engaging portion 28 and the top edge 243, a slope 242 bridging the third engaging section 27 and the top edge 243, and two chamfered edges 244, with one interconnecting the slope 241 and the top edge 243 and another interconnecting the second slope 242 and the top edge 243.

Moreover, the slope 211 of the first engaging portion 21 on the inner section 205 is circumferentially spaced from the slope 231 of the first engaging portion 23 on the outer section 206 at an angle of 180°; the slope 212 of the first engaging portion 21 on the inner section 205 is circumferentially spaced from the slope 232 of the first engaging portion 21 on the outer section 206 at an angle of 180°; the slope 221 of the second engaging portion 22 on the inner section 205 is circumferentially spaced from the slope 241 of the second engaging portion 24 on the outer section 206 at an angle of 180°; and the slope 222 of the second engaging portion 22 on the inner section 205 is circumferentially spaced from the slope 242 of the second engaging portion 24 on the outer section 206 at an angle of 180°.

FIG. 3 also shows that the engaging surface of the second member 30 defines an inner section 305 and an outer section 306. The inner section 305 has an inner perimeter that coincides with the perimeter of the hole 301 and an outer perimeter 303. The outer section 306 has an inner perimeter that coincides with the outer perimeter 303 of the inner section 305 and an outer perimeter that coincides with a perimeter 304 of the engaging surface of the second member 30.

The inner section 305 has a first and a second engaging portions 31 and 32, preferably a protruded configuration, thereon and spaced by a third and a fourth engaging portions 35 and 36 forming portions of surface delimiting the inner section 305. The first, second, third and fourth engaging portions 31, 32, 35 and 36 have shapes symmetrical with respect to line V. Additionally, the first and second engaging portions 31 and 32 are disposed symmetrically with respect to line V and have their respective central angles with respect to point O being equal. Additionally, the third and fourth engaging portions 35 and 36 have their respective central angles with respect to point O halved by line V and therefore a line dividing the central angle of the third engaging portion 35 in half and a line dividing the central angle of the fourth engaging portion 36 in half cooperate to form an angle of 180° and these lines coincide with line V.

In addition, the first engaging portion 31 defines a top edge 313 which is preferably a planar surface, a slope 311 bridging the third engaging portion 35 and the top edge 313, a slope 312 bridging the fourth engaging portion 36 with the top edge 313, and two chamfered edges 314, with one interconnecting the slope 311 and the top edge 313 and another interconnecting the slope 312 and the top edge 313. The second engaging portion 32 defines a top edge 323 which is preferably a planar surface, a slope 321 bridging the fourth engaging portion 36 and the top edge 323, a slope 322 bridging the third engaging portion 35 with the top edge 323, and two chamfered edges 324, with one interconnecting the slope 321 and the top edge 323 and another interconnecting the slope 322 and the top edge 323.

The outer section 306 has a first and a second engaging portions 33 and 34, preferably a protruded configuration, thereon and spaced by a third and a fourth engaging portions 37 and 38 forming portions of surface defining the outer section 206. The first, second, third and fourth engaging portions 33, 34, 37 and 38 have shapes symmetrical with respect to line V. Additionally, the first and second engaging portions 33 and 34 are disposed symmetrically with respect to line V and have their respective central angles with respect to point O being equal. Additionally, the third and fourth engaging portions 37 and 38 have their respective central angles with respect to point O halved by line V and therefore a line dividing the central angle of the third engaging portion 37 in half and a line dividing the central angle of the fourth engaging portion 38 in half cooperate to form an angle of 180° and these lines coincide with line V.

Moreover, a line dividing the central angle of the first engaging portion 31 on the inner section 305 in half and a line dividing the central angle of the first engaging portion 33 on the outer section 306 in half cooperate to form an angle of 180°; a line dividing the central angle of the second engaging portion 32 on the inner section 305 in half and a line dividing the central angle of the second engaging portion 34 on the outer section 306 in half cooperate to form an angle of 180°.

Moreover, the slope 311 of the first engaging portion 31 on the inner section 305 is circumferentially spaced from the slope 331 of the first engaging portion 33 on the outer section 306 at an angle of 180°; the slope 312 of the first engaging portion 31 on the inner section 305 is circumferentially spaced from the slope 332 of the first engaging portion 33 on the outer section 206 at an angle of 180°; the slope 321 of the second engaging portion 32 on the inner section 305 is circumferentially spaced from the slope 341 of the second engaging portion 34 on the outer section 306 at an angle of 180°; and the slope 322 of the second engaging portion 32 on the inner section 305 is circumferentially spaced from the slope 342 of the second engaging portion 34 on the outer section 306 at an angle of 180°.

In addition, the first engaging portion 33 defines a top edge 333 which is preferably a planar surface, a slope 331 bridging the third engaging portion 37 and the top edge 333, a slope 332 bridging the fourth engaging section 38 and the top edge 333, and two chamfered edges 334, with one interconnecting the slope 331 and the top edge 333 and another interconnecting the second slope 332 and the top edge 333. The second engaging portion 34 defines a top edge 343 which is preferably a planar surface, a slope 341 bridging the fourth engaging portion 38 and the top edge 343, a slope 342 bridging the third engaging section 37 and the top edge 343, and two chamfered edges 344, with one interconnecting the slope 341 and the top edge 343 and another interconnecting the slope 342 and the top edge 343.

The central angles of the first engaging portion 21 of the first member 20 and third engaging portions 35 of the second member 30 are substantially equal, the central angles of the second engaging portion 22 of the first member 20 and the fourth engaging portions 36 of the second member 30 are substantially equal, the central angles of the first engaging portion 23 of the first member 20 and the third engaging portions 37 of the second member 30 are substantially equal, and the central angles of the second engaging portion 24 of the first member 20 and the fourth engaging portions 38 of the second member 30 are substantially equal. Also, the central angles of the first engaging portion 31 of the second member 30 and third engaging portions 25 of the first member 20 are substantially equal, the central angles of the second engaging portion 32 of the second member 30 and the fourth engaging portions 26 of the first member 20 are substantially equal, the central angles of the first engaging portion 33 of the second member 30 and the third engaging portions 27 of the first member 20 are substantially equal, and the central angles of the second engaging portion 34 of the second member 30 and the fourth engaging portions 28 of the first member 30 are substantially equal. Thus, the first and second members 20 and 30 can be positioned with respect to each other such that the engaging portions 21, 22, 23 and 24 are complemently received in the engaging portions 35, 36, 37, and 38 and the engaging portions 31, 32, 33 and 34 are complemently received in the engaging portions 25, 26, 27, and 28, as shown in FIG. 3.

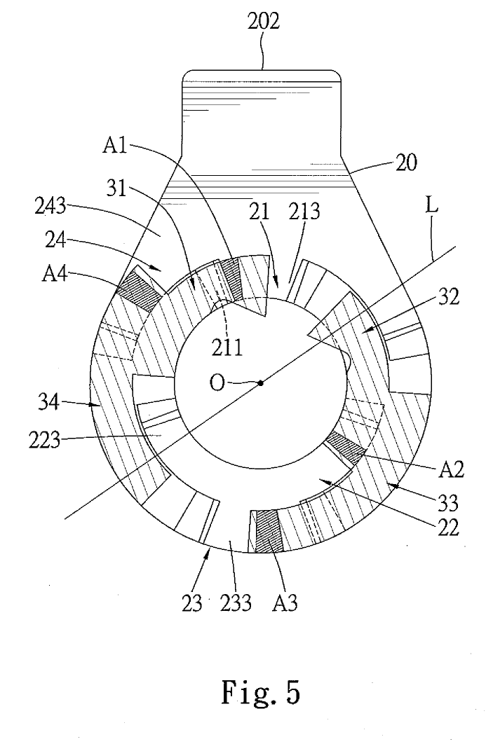

When the second member 30 is rotated clockwise with respect to first member 20, as best shown in FIG. 5, the top edge 313 defined by the first engaging portion 31 at the inner section 305 of the second member 30 is moved to gradually engage with the top edge 213 defined by the first engaging portion 21 at the inner section 205 of the second member 20, and this area of contact is defined as A1. The top edge 323 defined by the second engaging portion 32 at the inner section 305 of the second member 30 is moved to gradually engage with the top edge 223 defined by the second engaging portion 22 at the inner section 205 of the second member 20, and the area of contact is defined as A2. The top edge 333 defined by the first engaging portion 33 at the outer section 306 of the second member 30 is moved to gradually engage with the top edge 233 defined by the first engaging portion 23 at the outer section 206 of the first member 20, and this area of contact is defined as A3. The top edge 343 defined by the second engaging portion 34 at the outer section 306 of the second member 30 is moved to gradually engage with the top edge 243 defined by the second engaging portion 24 at the outer section 206 of the first member 20, and this area of contact is defined as A4.

Preferably, areas A1 and A2 are kept symmetrical with respect to line L and areas A3 and A4 are kept symmetrical with respect to line L, respectively. Line L is a line passing through point O. Thus, the second member 30 can engage with the first member 20 in a very stable manner and it is not a problem that any elastic behavior would rock the engagement throughout the process, particularly at initial stage thereof, which is normally a problem of the conventional cam devices.

In addition, the top edge 313 can be easily pushed to engage with the top edge 213 (area of contact is defined as A1) without any rocking movement by cooperation of the slope 211 and the chamfered edge 214 between the slope 211 and the top edge 213 with the slope 311 and the chamfered edge 314 between the slope 311 and the top edge 313. Likewise, the top edge 313 can be easily pushed to disengage with top edge 213 without any rocking movement by cooperation of the slope 212 and the chamfered edge 214 between the slope 212 and the top edge 213 with the slope 312 and the chamfered edge 314 between the slope 312 and the top edge 313. Similarly, other engagement of top edges involved, such as A2, A3, and A4, would also be easily performed without any rocking movement.

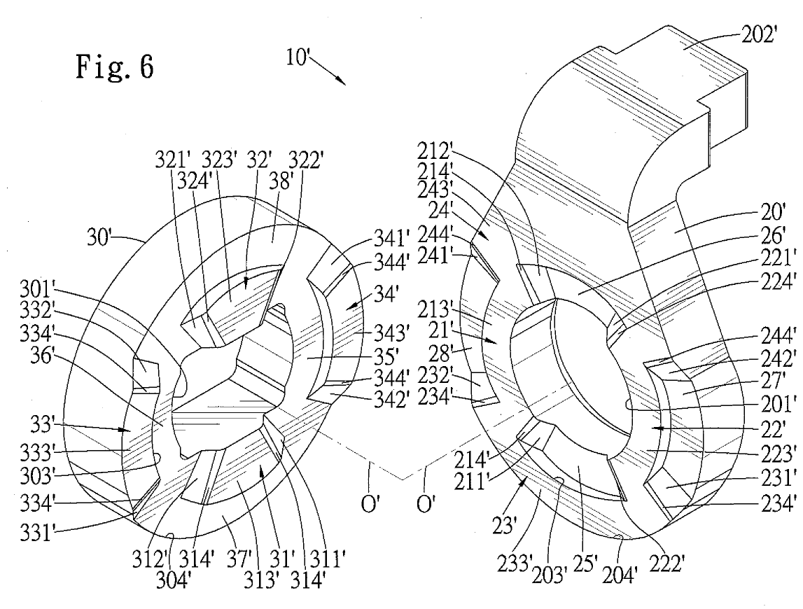

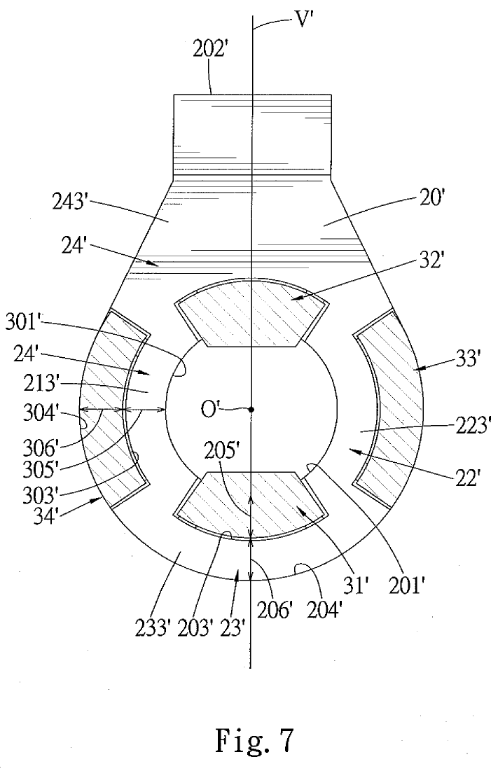

FIGS. 6 and 7 show an alternate cam device 10′ in accordance with a second embodiment of the present invention. Similar to the prior embodiment, a line dividing a central angle (measured with respect to O) of the first engaging portion 21′ on the inner section 205′ of the first member 20′ in half and a line dividing a central angle (measured with respect to O) of second engaging portion 22′ on the inner section 205′ of the first member 20′ in half cooperate to form an angle of 180°; and a line dividing a central angle (measured with respect to O) of the first engaging portion 23′ on the outer section 206′ of the first member 20′ in half and a line dividing a central angle (measured with respect to O) of the second engaging portion 24′ on the outer section 206′ of the first member 20′ in half cooperate to form an angle of 180°. But the lines associated with the first and second engaging portions 21′ and 22′ and the lines associated with the first and second engaging portions 23′ and 24′ cooperate to form an angle of 90°.

Additionally, the slope 211′ of the first engaging portion 21′ on the inner section 205′ is spaced from the slope 221′ of the second engaging portion 22′ on the inner section 205′ at an angle of 180°; the slope 212′ of the first engaging portion 21′ on the inner section 205′ is spaced from the slope 222′ of the second engaging portion 22 on the inner section 205′ at an angle of 180°; the slope 231′ of the first engaging portion 22′ on the outer section 306′ is spaced from the slope 241′ of the second engaging portion 24′ on the outer section 206′ at an angle of 180°; and the slope 232′ of the second engaging portion 23′ on the outer section 206′ is spaced from the slope 242′ of the second engaging portion 24′ on the outer section 206′ at an angle of 180°.

Also, a line dividing a central angle (measured with respect to O) of the first engaging portion 31′ on the inner section 305′ of the second member 30′ in half and a line dividing a central angle (measured with respect to O) of the second engaging portion 32′ on the inner section 305′ of the second member 30′ in half cooperate to form an angle of 180°; a line dividing the central angle of the first engaging portion 33′ on the outer section 306′ of the second member 30′ in half and a line dividing a central angle of the second engaging portion 34′ on the outer section 306′ of the second member 30′ in half cooperate to form an angle of 180°. The lines associated with the first and second engaging portions 31′ and 32′ and the lines associated with the first and second engaging portions 33′ and 34′ cooperate to form an angle of 90°.

While the specific embodiments have been illustrated and described, numerous modifications come to mind without significantly departing from the spirit of invention and the scope of invention is only limited by the scope of accompanying claims.

What is claimed is:

1. A cam device comprising:
a first member having an engaging surface defining an inner section and an outer section, the inner section including a first and a second engaging portions, the first engaging portion including a top edge having two ends, a first slope extending from one end of the top edge, and a second slope extending from the other end of the top edge, the second engaging portion including a top edge having two ends, a first slope extending the one end of the top edge and a second slope extending from the other end of the top edge, the outer section has a first and a second engaging portions, the first engaging portion including a top edge having two ends, a first slope extending from one end of the top edge, and a second slope extending from the other end of the top edge, the second engaging portion including a top edge having two ends, a first slope extending from one end of the top edge and a second slope extending from the other end of the top edge, with the first slope of the first engaging portion on the inner section circumferentially spaced from the first slope of the first engaging portion on the outer section at an angle of 180°, with the first slope of the second engaging portion on the inner section circumferentially spaced from the first slope of the second engaging portion on the outer section at an angle of 180°, the first and second engaging portions on the inner section having respective central angles measured from an imaginary point defined within the cam device and imaginary lines dividing the central angles in half cooperating to form an angle of 180°; and the first and second engaging portions on the outer section having central angles measured with respect to the point and imaginary lines dividing the central angles in half cooperating to form an angle of 180°; and
a second member having an engaging surface positioned against the engaging surface of the first member and moveable relative to the engaging surface of the first member, with the engaging surface defining an inner section and an outer section, the inner section including a first and a second engaging portions, the first engaging portion including a top edge having two ends, a first slope extending from one end of the top edge, and a second slope extending from the other end of the top edge, the second engaging portion including a top edge having two ends, a first slope extending from one end of the top edge and a second slope extending from the other end of the top edge, the outer section has a first and a second engaging portions, the first engaging portion including a top edge having two ends, a first slope extending from one end of the top edge, and a second slope extending from the other end of the top edge, the second engaging portion including a top edge having two ends, a first slope extending from one end of the top edge and a second slope extending from the other end of the top edge, with the first slope of the first engaging portion on the inner section circumferentially spaced from the first slope of the first engaging portion on the outer section at an angle of 180°, with the first slope of the second engaging portion on the inner section spaced circumferentially from the first slope of the second engaging portion on the outer section at an angle of 180°, the first engaging portion on the inner section and the first engaging portion on the outer section having central angles measured with respect to the point and imaginary lines dividing the central angles in half cooperating to form an angle of 180°; and the second engaging portion on the inner section and the second engaging portion on the outer section having central angles measured with respect to the point and imaginary lines dividing the central angles in half cooperating to form an angle of 180°.

2. The cam device as claimed in claim 1, with the second slope of the first engaging portion on the inner section of the first member circumferentially spaced from the second slope of the first engaging portion on the outer section of the first member at an angle of 180°, with the second slope of the second engaging portion on the inner section of the first member spaced circumferentially from the second slope of the second engaging portion on the outer section of the first member at an angle of 180°, with the second slope of the first engaging portion on the inner section of the second member spaced circumferentially from the second slope of the first engaging portion on the outer section at an angle of 180°, and with the second slope of the second engaging portion on the inner section of the second member spaced circumferentially from the second slope of the second engaging portion on the outer section of the second member at an angle of 180°.

3. The cam device as claimed in claim 1 wherein the inner section of the first member further comprises a third engaging portion bridging the first slope of the first engaging portion and the second slope of the second engaging portion, and a fourth engaging portion bridging the second slope of the first engaging portion and the first slope of the second engaging portion, and wherein the outer section of the first member further comprises a third engaging portion bridging the first slope of the first engaging portion and the second slope of the second engaging portion, and a fourth engaging portion bridging the second slope of the first engaging portion and the first slope of the second engaging portion, and wherein the inner section of the second member further comprises a third engaging portion bridging the first slope of the first engaging portion and the second slope of the second engaging portion, and a fourth engaging portion bridging the second slope of the first engaging portion and the first slope of the second engaging portion, and wherein the outer section of the second member further comprises a third engaging portion bridging the first slope of the first engaging portion and the second slope of the second engaging portion, and a fourth engaging portion bridging the second slope of the first engaging portion and the first slope of the first engaging portion.

4. The cam device as claimed in claim 3 wherein the first and second members are positioned with respect to each other in a position wherein the first and second engaging portions on the inner section of the first member are complemently received in the third and fourth engaging portions on the inner section of the second member respectively, and wherein the first and second engaging portions on the outer section of the first member are complemently received in the third and fourth engaging portions on the outer section of the second member respectively, wherein the first and second engaging portions on the inner section of the second member are complemently received in the third and fourth engaging portions on the inner section of the first member respectively, and wherein the first and second engaging portions on the outer section of the second member are complemently received in the third and fourth engaging portions on the inner section of the first member respectively.

5. The cam device as claimed in claim 1 wherein the first engaging portions on the inner section of the first member further comprises two chamfered edges, with one chamfered edge interconnecting the first slope and the top edge and another interconnecting the second slope and the top edge, and wherein the second engaging portion on the inner section of the first member further comprises two chamfered edge, with one chamfered edge interconnecting the first slope and the top edge and another interconnecting the second slope and the top edge, and wherein the first engaging portions on the outer section of the first member further comprises two chamfered edges, with one chamfered edge interconnecting the first slope and the top edge and another interconnecting the second slope and the top edge, and wherein the second engaging portion on the outer section of the first member further comprises two chamfered edges, with one chamfered edge interconnecting the first slope and the top edge and another interconnecting the second slope and the top edge, and wherein the first engaging portions on the inner section of the second member further comprises two chamfered edges, with one chamfered edge interconnecting the first slope and the top edge and another interconnecting the second slope and the top edge, and wherein the second engaging portion on the inner section of the second member further comprises two chamfered edges, with one chamfered edge interconnecting the first slope and the top edge and another interconnecting the second slope and the top edge, and wherein the first engaging portions on the outer section of the second member further comprises two chamfered edges, with one chamfered edge interconnecting the first slope and the top edge and another interconnecting the second slope and the top edge, and wherein the second engaging portion on the outer section of the second member further comprises two chamfered edges, with one chamfered edge interconnecting the first slope and the top edge and another interconnecting the second slope and the top edge.

6. The cam device comprising:
a first member having an engaging surface defining an inner section and an outer section, the inner section including a first and a second engaging portions, the first engaging portion including a top edge having two ends, a first slope extending from one end of the top edge, and a second slope extending from the other end of the top edge, the second engaging portion including a top edge having two ends, a first slope extending the one end of the top edge and a second slope extending from the other end of the top edge, the outer section has a first and a second engaging portions, the first engaging portion including a top edge having two ends, a first slope extending from one end of the top edge, and a second slope extending from the other end of the top edge, the second engaging portion including a top edge having two ends, a first slope extending from one end of the top edge and a second slope extending from the other end of the top edge, with the first slope of the first engaging portion on the inner section spaced circumferentially from the first slope of the second engaging portion on the inner section at an angle of 180°, with the first slope of the first engaging portion on the outer section spaced circumferentially from the first slope of the second engaging portion on the outer section at an angle of 180°, the first and second engaging portions on the inner section having respective central angles measured from an imaginary point defined within the cam device and imaginary lines dividing the central angles in half cooperating to form an angle of 180°; and the first and second engaging portions on the outer section having central angles measured with respect to the point and imaginary lines dividing the central angles in half cooperating to form an angle of 180°, and the lines associated to with the first and second engaging portions on the inner section and the lines associated with the first and second engaging portions on the outer section cooperating to form an angle of 90°; and
a second member having an engaging surface positioned against the engaging surface of the first member and moveable relative to the engaging surface of the first member, with the engaging surface defining an inner section and an outer section, the inner section including a first and a second engaging portions, the first engaging portion including a top edge having two ends, a first slope extending from one end of the top edge, and a second slope extending from the other end of the top edge, the second engaging portion including a top edge having two ends, a first slope extending from one end of the top edge and a second slope extending from the other end of the top edge, the outer section has a first and a second engaging portions, the first engaging portion including a top edge having two ends, a first slope extending from one end of the top edge, and a second slope extending from the other end of the top edge, the second engaging portion including a top edge having two ends, a first slope extending from one end of the top edge and a second slope extending from the other end of the top edge, with the first slope of the first engaging portion on the inner section spaced circumferentially from the first slope of the second engaging portion on the inner section at an angle of 180°, with the first slope of the first engaging portion on the outer section spaced circumferentially from the first slope of the second engaging portion on the outer section at an angle of 180°, the first engaging portion on the inner section and the second engaging portion on the inner section having central angles measured with respect to the point and imaginary lines dividing the central angles in half cooperating to form an angle of 180°; and the first engaging portion on the outer section and the second engaging portion on the outer section having central angles measured with respect to the point and imaginary lines dividing the central angles in half cooperating to form an angle of 180°, and the lines associated with the first and second engaging portions on the inner section and the lines associated with the first and second engaging portions on the outer section cooperating to form an angle of 90°.

7. The cam device as claimed in claim 6, with the second slope of the first engaging portion on the inner section of the first member circumferentially spaced from the second slope of the second engaging portion on the inner section of the first member at an angle of 180°, with the second slope of the first engaging portion on the outer section of the first member spaced circumferentially from the second slope of the second engaging portion on the outer section of the first member at an angle of 180°, with the second slope of the first engaging portion on the inner section of the second member spaced circumferentially from the second slope of the second engaging portion on the inner section at an angle of 180°, and with the second slope of the first engaging portion on the outer section of the second member spaced circumferentially from the second slope of the second engaging portion on the outer section of the second member at an angle of 180°.

8. The cam device as claimed in claim 6 wherein the inner section of the first member further comprises a third engaging portion bridging the first slope of the first engaging portion and the second slope of the second engaging portion, and a fourth engaging portion bridging the second slope of the first engaging portion and the first slope of the second engaging portion, and wherein the outer section of the first member further comprises a third engaging portion bridging the first slope of the first engaging portion and the second slope of the second engaging portion, and a fourth engaging portion bridging the second slope of the first engaging portion and the first slope of the second engaging portion, and wherein the inner section of the second member further comprises a third engaging portion bridging the first slope of the first engaging portion and the second slope of the second engaging portion, and a fourth engaging portion bridging the second slope of the first engaging portion and the first slope of the second engaging portion, and wherein the outer section of the second member further comprises a third engaging portion bridging the first slope of the first engaging portion and the second slope of the second engaging portion, and a fourth engaging portion bridging the second slope of the first engaging portion and the first slope of the first engaging portion.

9. The cam device as claimed in claim 8 wherein the first and second members are positioned with respect to each other in a position wherein the first and second engaging portions on the inner section of the first member are complemently received in the third and fourth engaging portions on the inner section of the second member respectively, and wherein the first and second engaging portions on the outer section of the first member are complemently received in the third and fourth engaging portions on the outer section of the second member respectively, wherein the first and second engaging portions on the inner section of the second member are complemently received in the third and fourth engaging portions on the inner section of the first member respectively, and wherein the first and second engaging portions on the outer section of the second member are complemently received in the third and fourth engaging portions on the inner section of the first member respectively.

10. The cam device as claimed in claim 6 wherein the first engaging portions on the inner section of the first member further comprises two chamfered edges, with one chamfered edge interconnecting the first slope and the top edge and another interconnecting the second slope and the top edge, and wherein the second engaging portion on the inner section of the first member further comprises two chamfered edges, with one chamfered edge interconnecting the first slope and the top edge and another interconnecting the second slope and the top edge, and wherein the first engaging portions on the outer section of the first member further comprises two chamfered edges, with one chamfered edge interconnecting the first slope and the top edge and another interconnecting the second slope and the top edge, and wherein the second engaging portion on the outer section of the first member further comprises two chamfered edges, with one chamfered edge interconnecting the first slope and the top edge and another interconnecting the second slope and the top edge, and wherein the first engaging portions on the inner section of the second member further comprises two chamfered edges, with one chamfered edge interconnecting the first slope and the top edge and another interconnecting the second slope and the top edge, and wherein the second engaging portion on the inner section of the second member further comprises two chamfered edges, with one chamfered edge interconnecting the first slope and the top edge and another interconnecting the second slope and the top edge, and wherein the first engaging portions on the outer section of the second member further comprises two chamfered edges, with one chamfered edge interconnecting the first slope and the top edge and another interconnecting the second slope and the top edge, and wherein the second engaging portion on the outer section of the second member further comprises two chamfered edges, with one chamfered edge interconnecting the first slope and the top edge and another interconnecting the second slope and the top edge.
